(19) United States
(12) Patent Application Publication
(10) Pub. No.: US 2005/0073402 A1
(43) Pub. Date: Apr. 7, 2005

(54) Method of provisioning alarms and performance monitoring for a network element

(75) Inventor: John Denyer, Nepean (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Nortel Networks Limited, St. Laurent (CA)

(21) Appl. No.: 10/776,947

(22) Filed: Feb. 11, 2004

Related U.S. Application Data
(60) Provisional application No. 60/509,336, filed on Oct. 7, 2003.

(51) Int. Cl. G08C 15/00

(52) U.S. Cl. 340/500; 370/216; 709/224

(57) ABSTRACT

Described is a method for provisioning status monitoring for a network element in a communications network. Multiple predefined templates are provided to a user. Each template corresponds to a particular facility type and includes multiple profiles. Each profile includes a value for each of a plurality of status types. One of the profiles is selected for an instantiation of the facility type in the network element to implement status monitoring. The status monitoring is responsive to the values in the selected profile. Each value can define a reporting state for a respective one of a plurality of alarm types. Alternatively, each profile can define a threshold value for a respective one of a plurality of performance parameters. Optionally, one or more values in a selected profile can be edited by the user.

### CROSS-REFERENCE TO RELATED APPLICATIONS

This application claims the benefit of U.S. provisional patent application Ser. No. 60/509,336, filed Oct. 7, 2003, titled “Method of Provisioning Alarms and Performance Monitoring for a Network Element”, the entirety of which provisional application is incorporated by reference herein.

### FIELD OF THE INVENTION

The invention relates generally to alarm reporting and performance monitoring. In particular, the invention relates to a method for efficiently provisioning alarm reporting and provisioning performance monitoring for network elements in communications systems.

### BACKGROUND

Network elements used in communications networks generally have some ability to report alarm conditions as they are recognized at the network element. Often the number of alarms that are reported is large, making the task of interpreting the alarms difficult. For many network elements, the alarms of interest can be substantially less than the total number of alarms available for reporting. A user may elect to disable certain alarms for each facility instantiation that are not of interest to eliminate their reporting, however, the user must manually disable individual alarms under this process. In a similar fashion, the user may have to manually enable any disabled (or inhibited) alarms corresponding to each facility instantiation if the default setting for the alarm is a disabled status.

Management of communication networks is based in part on monitoring various performance parameters. A performance parameter typically corresponds to the number of events of a specific type that occur within a predetermined time interval. If the value of the performance parameter exceeds an associated threshold value, an autonomous output event is generated for that parameter.

Users may desire to use non-standard threshold values for the various performance parameters, thus making the provisioning of performance parameters a significant task. Moreover, the performance parameters of interest for multiple instantiations of a common facility type are often the same, but a user provisioning performance parameters for the network element or group of network elements has to set the individual threshold values that differ from the corresponding default threshold values for each facility instantiation.

Thus there exists a need to provide a user with a method to efficiently provision alarm reporting and performance monitoring for various facility instances in network elements.

### SUMMARY OF THE INVENTION

In one aspect the invention features a method for provisioning alarm monitoring for a network element in a communications network. The method includes providing to a user a predefined alarm template having multiple alarm profiles for a facility type and selecting one of the alarm profiles for an instantiation of the facility type in the network element. Each of the alarm profiles defines a reporting state for each of a plurality of alarm types. In one embodiment the method also includes editing the reporting state of at least one of the alarm types in the selected alarm profile. In another embodiment the method also includes assigning the selected alarm profile as a default alarm profile for provisioning another instantiation of the facility type.

In another aspect the invention features a method for provisioning performance monitoring for a network element in a communications network. The method includes providing to a user a predefined performance template having multiple performance profiles for a facility type and selecting one of the performance profiles for an instantiation of the facility type in the network element. Each of the performance profiles defines a threshold value for each of a plurality of performance parameters. In one embodiment the method also includes editing the threshold value of at least one of the performance parameters in the selected performance profile. In another embodiment the method also includes assigning the selected performance profile as a default performance profile for provisioning another instantiation of the facility type.

In another aspect the invention features a method for provisioning status monitoring for a network element in a communications network. The method includes providing to a user a plurality of predefined templates each corresponding to a respective one of a plurality of facility types. Each predefined template includes multiple profiles for the respective facility type. Each profile has a value for each of a plurality of status types. The method also includes selecting one of the profiles for an instantiation of the facility type in the network element to implement status monitoring responsive to the values of the selected profile. In one embodiment each of the profiles for one of the predefined templates defines a reporting state for each of a plurality of alarm types. In another embodiment each of the profiles for one of the predefined templates defines a threshold value for each of a plurality of performance parameters. In yet another embodiment the method also includes editing one of the values of the selected profile.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a flowchart representation of an embodiment of a method for provisioning alarm monitoring for a network element in a communications network according to the invention.

FIG. 2 is an illustration of an example of a predefined alarm template in accordance with the invention.

FIG. 3 is a flowchart representation of an embodiment of a method for provisioning performance monitoring for a network element in a communications network according to the invention.

FIG. 4 is an illustration of an example of a predefined performance template in accordance with the invention.

### DETAILED DESCRIPTION

In brief overview, the present invention relates to a method for provisioning status monitoring for a network element in a communications network. According to the method, the user is provided with predefined templates. Each predefined template is associated with a facility type supported by the network element and includes multiple profiles. Each profile has a set of values corresponding to a set of status parameters to be monitored. In one embodiment the status parameters are reporting states associated with various alarm types indicative of the operational status of the respective facility instantiation. Each value indicates whether the reporting of the corresponding alarm type is enabled or inhibited. Alternatively, each status parameter can be a performance parameter defined according to the number of events of a specific type that occur within a predetermined time interval. The user selects one of the profiles for an instantiation of the facility type in the network element. Subsequent status monitoring is responsive to the values defined in the selected profile.

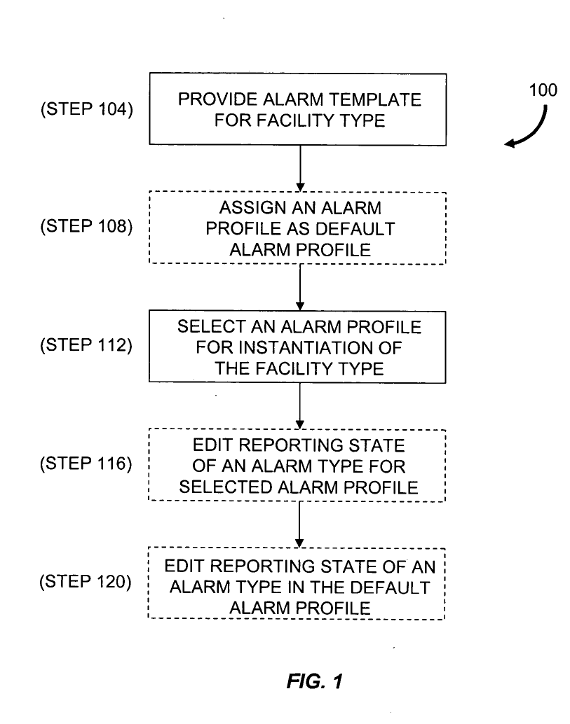

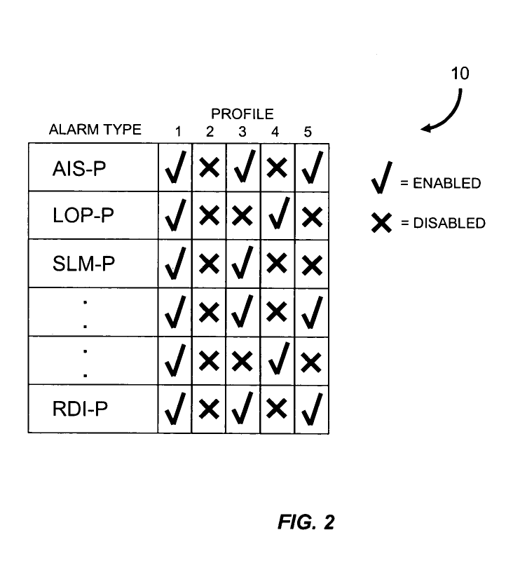

Referring to FIG. 1, in one embodiment, a method 100 for provisioning alarm monitoring for a network element in a communications network according to the invention includes providing (step 104) a user with a predefined alarm template having a plurality of alarm profiles for a facility type. An example of a predefined alarm template 10 is shown in FIG. 2. Each of the alarm profiles is described by one of the five columns labeled profile 1 through profile 5 and defines a reporting state for each member of a set of alarms types. The reporting state indicates whether the associated alarm is to be reported in the user's session. Although only one predefined alarm template 10 is shown, a user may have access to any number of predefined alarm templates according to the number of facility types that may be provisioned. For example, a separate predetermined alarm template can be presented to the user for each facility type such as STS-1, DS-3 and OC-48 facilities. During provisioning of the network element, the predetermined alarm template 10 for each facility type can be assigned (step 108) a default alarm profile for convenience. The user can select (step 112) the default alarm profile for an instantiation of the facility type. Alternatively, another alarm profile in the predefined alarm template 10 can be selected for the instantiation. Some of the profiles are editable by the user, allowing further definition of the alarms types to be reported. Thus the user has the convenience of selecting from a set of predefined profiles to quickly establish the desired alarm set for reporting and the flexibility of editing (step 116) certain alarm profiles, including editing (step 120) the default alarm profile, for further customization.

The illustrative predetermined alarm template 10 is associated with an STS-1 facility type and includes an alarm type list and five associated profiles. Other facility types (e.g., OC-3, DS-3, STS-12c and OC-48) have independent alarm templates with profiles that are generally based on a different listing of alarm types, although there can be some alarm types common to different facility types. The alarm types include an (AIS-P) loss of pointer (LOP-P), signal label mismatch (SLM-P), remote defect indicator (RDI-P) for the path, and may include additional alarm types. Although five profiles are shown, it should be recognized that the number of profiles associated with an alarm template can be different.

Each profile is represented by a respective vertical column displaying a check “V” to indicate an enabled alarm type or an “X” to indicate a disabled, or inhibited, alarm type. Profile 1 is used to enable the reporting of all alarm types and profile 2 is used to inhibit the reporting of all alarms types. Neither profile 1 nor profile 2 is editable by the user. Profiles 3, 4 and 5 can be edited by the user and are initially seeded to enable all the alarms. In one embodiment one or more of the alarm types in the editable profiles are locked (i.e., unavailable for edit). In the illustrative example none of the five profiles can be deleted although it should be generally understood that any number of the profiles can be preset to prevent editing. Optionally, the predefined alarm template 10 is associated with a network element even if the associated facility type is not implemented on the network element. In one embodiment each alarm profile is uniquely referenced by its facility type and a fixed label.

During provisioning, the user can designate any one of the five alarm profiles as the default alarm profile although the default alarm profile is initially set, for example, to be profile 1 (all alarms enabled). When a facility is instantiated, it is automatically assigned the current default alarm profile for that facility type. However, if a different alarm profile is selected to be the default alarm profile, any facility instances previously provisioned according to the prior default alarm profile will continue to use the prior default alarm profile. If a default alarm profile is edited, any facility instances using the same default alarm profile receive the changes.

If an alarm profile referenced by a facility instance is switched (or transitioned) to a different alarm profile, alarm reporting is affected during the transition. More specifically, if an active enabled alarm type is disabled, an alarm clear is issued with the transition time as a timestamp and the alarm type is removed from the active alarm list. An alarm raise is added to the active disabled alarm list using the transition time as the associated timestamp. Similarly, if an active disabled alarm type is enabled, the alarm type is removed from the active disabled list and added to the active alarm list, and an alarm raise is issued with the transition time as the associated timestamp.

The present invention also relates to a method of provisioning performance monitoring on network elements. Performance monitoring refers to a dynamic background evaluation of in-service connections implemented through a network element. Performance monitoring evaluates certain performance parameters such as bit errors, defects, and particular irregularities, or “glitches”, observed in alarm signals. The number of errors associated with each observed performance parameter are counted during predetermined time intervals and compared with a threshold value designated for the performance parameter. The threshold values are provisioned by the user. If the monitored performance parameter exceeds its threshold value during the time interval, an autonomous message, or “threshold crossing alert”, is provided to the user's session to provide an early warning that some portion of the network, or a signal in the nework, may be degrading.

Previous methods for provisioning performance monitoring were based on editing individual values in a single default set of seeded (i.e., predefined before deployment) threshold values provided for the facility type. Corresponding facility instances are then automatically updated to the edited set of threshold values, however, the user can individual select particular threshold values to use for a particular facility instance.

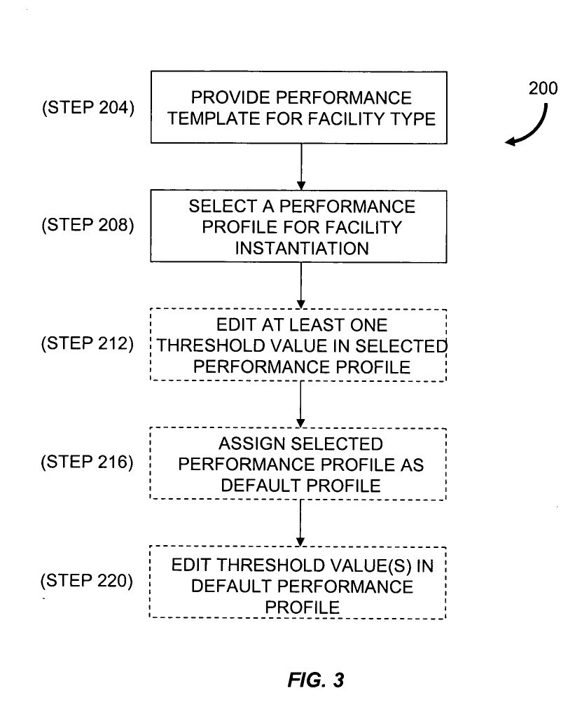

The method of provisioning performance monitoring according to the present invention is convenient and flexible. The method shares some of the features and benefits described above for alarm provisioning. Referring to FIG. 3, in one embodiment, a method 200 for provisioning performance monitoring for a network element in a communications network according to the invention includes providing a user with a predefined performance template having a plurality of performance profiles for a facility type. The method 200 includes providing (step 204) a user with a predefined performance template having multiple performance profiles for a facility type. Each of the performance profiles defines a threshold value for a respective performance parameter. The user selects (step 208) one of the performance profiles for the instantiation of the facility type. Optionally, the method 200 also includes editing (step 212) the threshold value of at least one of the performance parameters in the selected performance profile. The user can also assign (step 216) the selected performance profile as the default profile. One or more of the threshold values in the default performance profile can be edited (step 220) for other instantiations of the facility type.

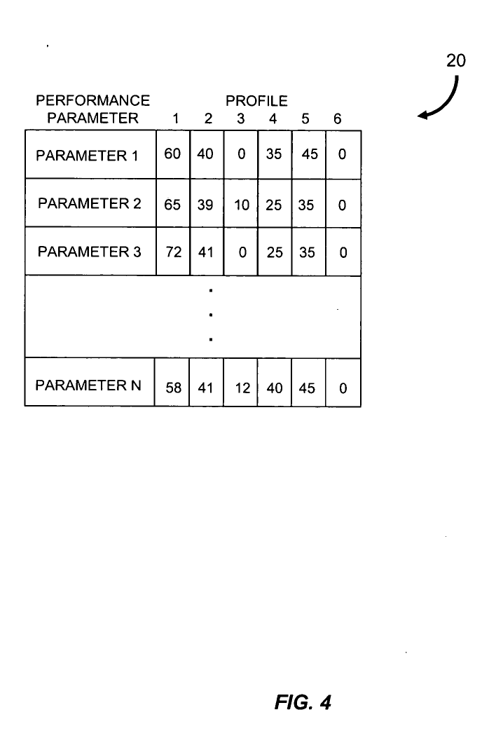

An example of a predefined performance template 20 for a specific facility type is shown in FIG. 4. Each column of the predefined performance template 20 represents one of the performance profiles and is designated according to a profile number (e.g. 1 to 6). Each of the performance profiles defines a threshold value for each of a set of N performance parameters available for monitoring for the facility type. By way of example, performance parameters can include CVP (code violations—path), ESP (errored seconds—path), SESP (severely errored seconds—path), UASP (unavailable seconds—path) and FCP (failure count—path). As shown, the predefined performance template includes six profiles, however it should be recognized that other numbers of profiles can be used, for example, to satisfy user requirements and design constraints. The threshold values are typically any value within a predefined range. Predefined performance templates for other facility types can be based on similar performance parameters and can include performance parameters that differ from those in the illustrated performance template 20. In addition, the number of performance parameters in a predefined performance template for a certain facility type is independent of the number of performance parameters defined for other performance templates.

The illustrative embodiment provides for a factory default set of threshold values (profile 5) defined according to a predetermined typical performance monitoring session. In addition, another set of threshold values (profile 6) of zero value allows performance monitoring autonomous reporting to be disabled. The other sets of threshold values (profiles 1, 2, 3 and 4) are seeded at the factory with “practical” values which can be later edited by the user. The autonomous reporting of individual performance parameters can be disabled in the editable profiles. For example, profile 3 has a zero value for two entries, indicating that threshold crossings for performance parameters 1 and 3 are not autonomously reported. The user can assign any of the six profiles to be the default profile for instances of a particular facility type.

In one embodiment the grade of service for a facility instance is coupled to an alarm profile or a performance parameter profile. For example, a user can select a grade which automatically implements a combination of a particular alarm profile and a particular performance parameter profile. Other grades correspond to other combinations of an alarm profile and a performance parameter profile.

While the invention has been shown and described with reference to specific embodiments, it should be understood by those skilled in the art that various changes in form and detail may be made therein without departing from the spirit and scope of the invention.

1. A method for provisioning alarm monitoring for a network element in a communications network, the method comprising:
providing to a user a predefined alarm template having a plurality of alarm profiles for a facility type, each of the alarm profiles defining a reporting state for each of a plurality of alarm types; and
selecting one of the alarm profiles for an instantiation of the facility type in the network element.

2. The method of claim 1 further comprising editing the reporting state of at least one of the alarm types in the selected alarm profile.

3. The method of claim 1 wherein the reporting states for at least one of the alarm profiles in the predefined alarm template cannot be edited by the user.

4. The method of claim 1 wherein the reporting state of all the alarm types for one of the alarm profiles is enabled.

5. The method of claim 1 wherein the reporting state of all the alarm types for one of the alarm profiles is inhibited.

6. The method of claim 1 further comprising assigning the selected alarm profile as a default alarm profile for provisioning another instantiation of the facility type.

7. The method of claim 6 further comprising editing the reporting state of one of the alarm types in the default alarm profile for the another instantiation of the facility type.

8. A method for provisioning performance monitoring for a network element in a communications network, the method comprising:
providing to a user a predefined performance template having a plurality of performance profiles for a facility type, each of the performance profiles defining a threshold value for each of a plurality of performance parameters; and
selecting one of the performance profiles for an instantiation of the facility type in the network element.

9. The method of claim 8 further comprising editing the threshold value of at least one of the performance parameters in the selected performance profile.

10. The method of claim 8 wherein the threshold values for at least one of the performance profiles in the predefined performance template cannot be edited by the user.

11. The method of claim 8 wherein the threshold value of all the performance parameters for one of the performance profiles is zero.

12. The method of claim 8 further comprising assigning the selected performance profile as a default performance profile for provisioning another instantiation of the facility type.

13. The method of claim 12 further comprising editing the threshold value of one of the performance parameters in the default performance profile for the another instantiation of the facility type.

14. A method for provisioning status monitoring for a network element in a communications network, the method comprising:
providing to a user a plurality of predefined templates corresponding to a respective one of a plurality of facility types, each predefined template including a plurality of profiles for the respective facility type, each profile having a value for each of a plurality of status types; and
selecting one of the profiles for an instantiation of the facility type in the network element to implement status monitoring responsive to the values of the selected profile.

15. The method of claim 14 wherein each of the profiles for one of the predefined templates defines a reporting state for each of a plurality of alarm types.

16. The method of claim 14 wherein each of the profiles for one of the predefined templates defines a threshold value for each of a plurality of performance parameters.

17. The method of claim 14 further comprising editing one of the values of the selected profile.
